(19) United States
(12) Patent Application Publication
(10) Pub. No.: US 2004/0256854 A1
(43) Pub. Date: Dec. 23, 2004

(54) Fitting for fluid conveyance

(76) Inventors: Gregory A. Haunhorst, Perrysburg, OH (US); Jason A. Mangol, Grosse Pointe Park, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/800,537

(22) Filed: Mar. 15, 2004

Related U.S. Application Data
(60) Provisional application No. 60/461,108, filed on Apr. 8, 2003.

(51) Int. Cl. F16L 39/00

(52) U.S. Cl. 285/133.11

(57) ABSTRACT

A fluid connector is provided that includes a fluid conveying member having an interior fluid passageway and a fitting that includes a first fluid duct and a second fluid duct in communication with the first fluid duct. The fluid conveying member is sized for receipt in the first fluid duct and includes an opening defined by a retaining formation that secures the fitting to the fluid conveying member and provides the interior fluid passageway of the fluid conveying member in communication with second fluid duct. A method for assembling a fluid connector of the present invention is also provided.

### CROSS-REFERENCE TO RELATED APPLICATIONS

This application claims priority to U.S. provisional application 60/461,108 filed on Apr. 8, 2003, which is incorporated herein by reference in its entirety.

### FIELD OF THE INVENTION

The present invention relates to a hydraulic fitting and more specifically to a method for attaching a hydraulic fitting to a fluid conveying member, such as a tube, to provide a third fluid passageway.

### BACKGROUND OF THE INVENTION

The prior art teaches using a brazed connector between a break in a fluid transfer line to provide an additional outlet for use with various devices such as a sensor, switch or other fluid system component. These fluid transfer lines typically comprise tubing and may be made out of steel, aluminum, a copper material or other suitable material having similar properties. One type of connector is known as a “T-fitting”, an example of which is shown in FIGS. 1-3. To secure the fluid transfer lines to the T-fitting, the fluid transfer lines are typically brazed to the T-fitting. The brazing process necessarily introduces heat into the tubing and fitting, and destroys any pre-applied corrosion resistance on the various components, which requires that the completed assembly be recoated after brazing. The use of a brazing furnace and subsequent recoating is expensive and time consuming. Therefore, a need exists for an improved connector and method of assembling a connector that overcomes the limitations associated with the brazing process.

### BRIEF SUMMARY OF THE INVENTION

A fluid connector is provided that includes a fluid conveying member having an interior fluid passageway and a fitting that includes a first fluid duct and a second fluid duct in communication with the first fluid duct. The fluid conveying member is sized for receipt in the first fluid duct and includes an opening defined by a retaining formation that secures the fitting to the fluid conveying member and provides the interior fluid passageway of the fluid conveying member in communication with second fluid duct. A method for assembling a fluid connector of the present invention is also provided.

### BRIEF DESCRIPTION OF THE DRAWINGS

FIG. 1 is an exploded perspective view of a prior art connector that includes a T-fitting connected to two fluid conveying members;

FIG. 2 is a top view of the assembled connector of FIG. 1;

FIG. 3 is a partial cross-sectional view of the connector of FIGS. 1 and 2 taken along line 3-3 in FIG. 2;

FIG. 4 is a cross-sectional view of a connector according to an embodiment of the present invention that includes a T-fitting and a single fluid conveying member;

FIG. 5 is a cross-sectional view of a connector according to another embodiment of the present invention;

FIGS. 6-8 are detailed cross-sectional views of a method of assembling the connectors shown in FIGS. 4 and 5, according to an embodiment of the present invention;

FIG. 9 is a cross-sectional view of a connector according to another embodiment of the present invention, prior to securing a T-fitting on a fluid conveying member;

FIGS. 10-12 are cross-sectional views of a method of assembling the connector shown in FIG. 9, according to an embodiment of the present invention;

FIGS. 13 and 14 are cross-sectional views of a method of assembling a connector according to another embodiment of the present invention; and

FIG. 15 is a cross-sectional view of a connector according to another embodiment of the present invention.

### DETAILED DESCRIPTION OF THE INVENTION

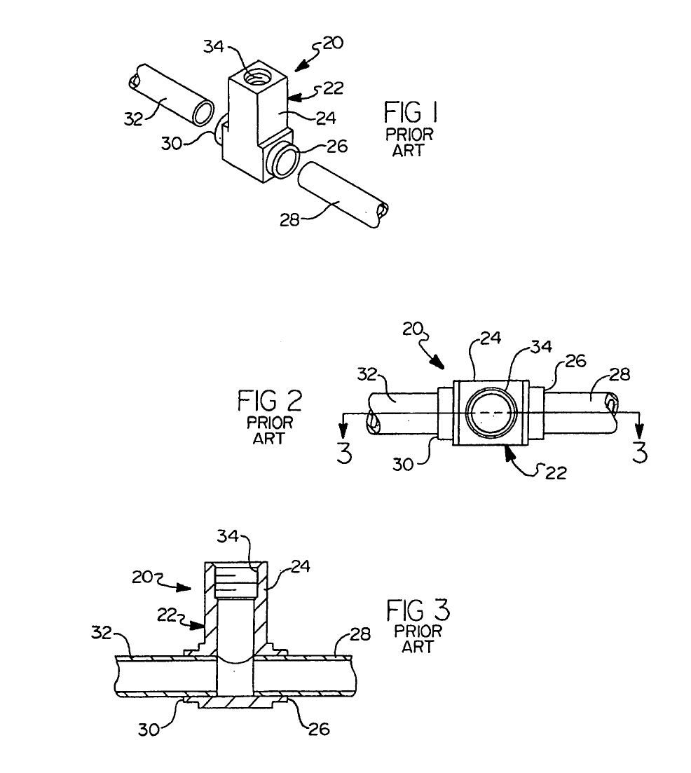

Referring to FIGS. 1-3, a prior art brazed connector 20 is shown that includes a “T-fitting” 22, so named because of its generally T-shaped body 24. Body 24 includes first port 26 configured for connection to a first fluid conveying member 28, such as a piece of cylindrical metal tubing, a second port 30 configured for connection to a second fluid conveying member 32, and a third port 34 configured for connection to a sensor, a switch or other fluid system component (not shown). In the prior art connector 20, fluid conveying members 28, 32 are connected to body 24 by brazing the fluid conveying members to the body in the region of their intersection.

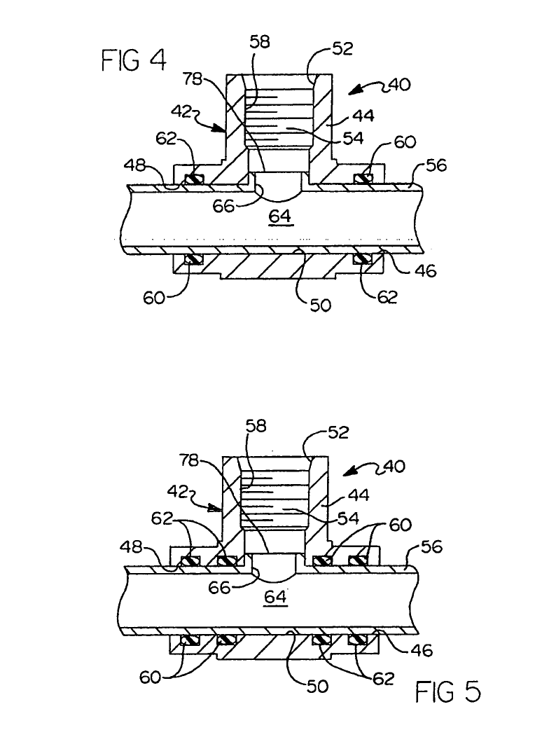

Referring to FIGS. 4 and 5, a connector 40 is shown according to an embodiment of the present invention. In the illustrated embodiment, connector 40 includes a T-shaped fitting 42, which is provided for comparison to the prior art connector 20 and is not intended to limit the scope of the invention. Fitting 42 includes a body 44 having first and second ports 46 and 48, respectively, which are connected by a first fluid duct 50, and a third port 52 that is provided in communication with first fluid duct 50 by a second fluid duct 54 shown as being generally orthogonal to first fluid duct 50. In an embodiment, first fluid duct 50 is sized for receipt of a fluid conveying member 56, such as a piece of cylindrical metal tubing. Third port 52 is configured for connection to various devices, such as a sensor, a switch or other fluid system component (not shown), and, as such, may include a threaded interface 58, for example, to facilitate this connection.

As shown in FIGS. 4 and 5, each of first and second ports 46, 48 may include at least one sealing member 60, such as an O-ring, installed in respective grooves 62 both upstream and downstream of second fluid duct 54. When fitting 42 is slid onto fluid conveying member 56, sealing members 60 provide a seal on the outside diameter of fluid conveying member 56 to provide a leak-free connection. Use of two or more sealing members 60 in each of ports 46, 48 (see, e.g., FIG. 5) is particularly useful for sealing against a tube that includes a nick or scratch in its outer surface, which would normally compromise the ability of sealing members 60 to provide a leak free connection but for the redundant sealing. Moreover, use of two or more sealing members permits the use of two or more different sealing materials that, in combination, can handle a broad range of temperatures and fluids. Alternatively, sealing members 60 may be located in grooves (not shown) formed in the outer surface of fluid conveying member 56 such that they seal against a smooth, internal surface of first fluid duct 50.

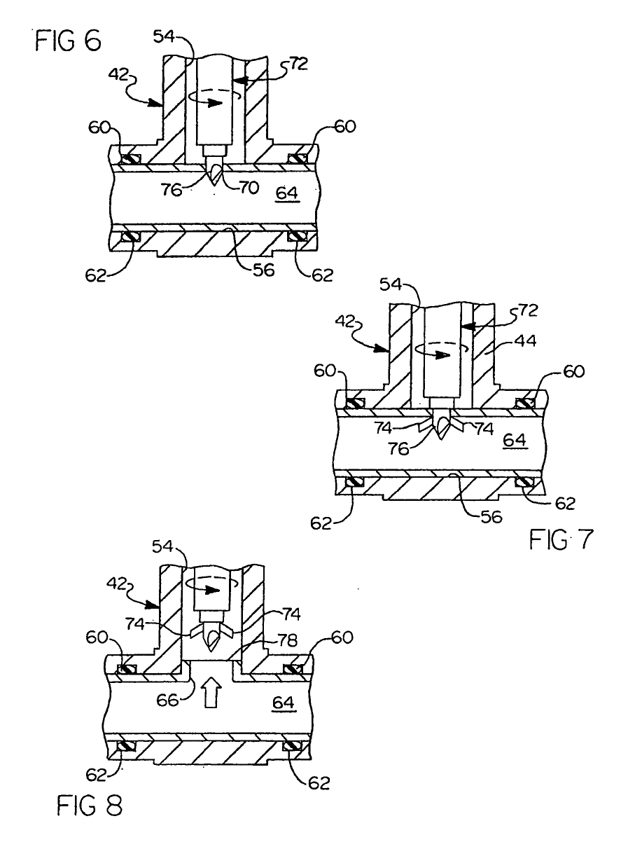

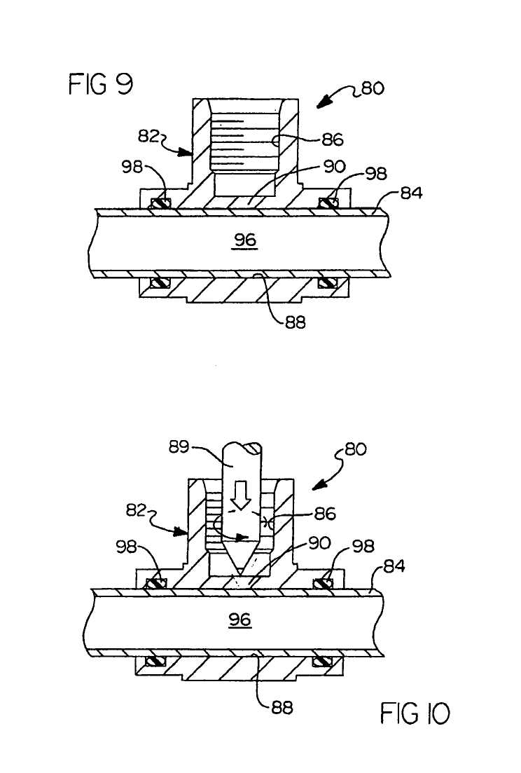

To provide second fluid duct 54 in communication with an interior fluid passageway 64 of fluid conveying member 56, an opening 66 is formed in fluid conveying member 56 between sealing members 60. In an embodiment, this opening is created using what is known as a “T-Drill®” process, as shown in FIGS. 6-8, whereby the displaced material formed during the manufacturing process functions to lock fitting 42 in place such that it cannot slide or rotate on fluid conveying member 56. In the “T-Drill®” process, as shown in FIGS. 6-8, a pilot hole 70 is drilled in fluid conveying member 56 using a special drilling tool 72 provided by T-Drill® Industries, Inc. of Norcross, Ga. (see FIG. 6). Once the pilot hole 70 is created, forming members 74 in a collaring head 76 of drilling tool 72 are extended within interior fluid passageway 64 of fluid conveying member 56 while the tool is rotating (see FIG. 7). While rotating, drilling tool 72 is withdrawn from fluid conveying member 56, as shown in FIG. 8, creating an integral collar 78 in a wall of fluid conveying member 56 that extends into second fluid duct 54. Collar 78 prevents movement of fitting 42 on fluid conveying member 56 and the opening 66 defined by collar 78 provides the interior fluid passageway 64 of fluid conveying member 56 in communication with second fluid duct 54.

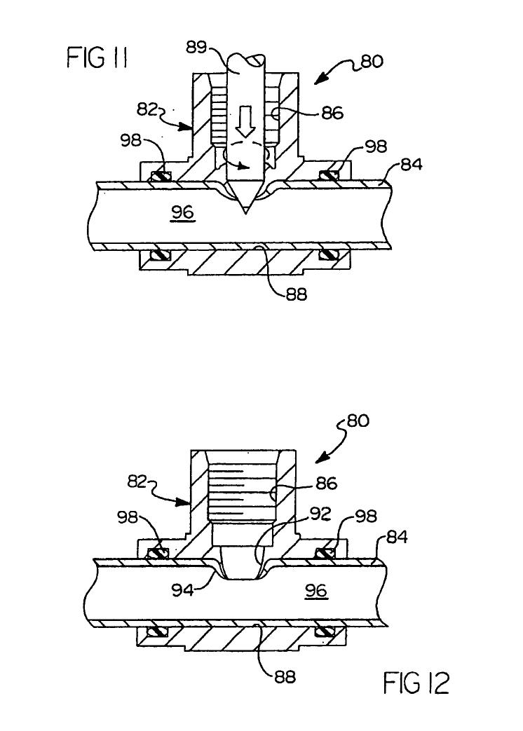

Referring to FIGS. 9-12, a connector 80 according to another embodiment of the present invention is shown. The embodiment shown in FIGS. 9-12 is substantially similar to connector 40 with at least one exception, namely, connector 80 uses a thermal drilling process, such as a “Flowdrill®” (or “Formdrill®”) thermal drilling process, to lock a fitting 82 in place on a fluid conveying member 84. To facilitate assembly, a first fluid duct 86 is not provided in communication with a second fluid duct 88, but includes a predetermined thickness of wall material 90 between first and second fluid ducts 86, 88. The Flowdrill® (or “Formdrill®”) thermal drilling process uses friction generated from the combined rotational and downward force of a special Flowdrill® (or “Formdrill®”) tool 89, provided by Flowdrill, Inc. of St. Louis, Mo. (or Unimex of Belgium) and shown in FIGS. 10 and 11, which penetrates wall material 90 of fitting 82 and fluid conveying member 84. Unlike prior art processes, however, the thermal energy is localized, minimizing any potential damage to corrosion resistant coatings. As shown in FIG. 11, the thermal drilling process heats and displaces a portion of wall material 90 and a portion of fluid conveying member 84, which results in a mechanical interlocking of fitting 82 with fluid conveying member 84. More particularly, friction and pressure developed and applied by the engagement of tool 89 with wall material 90 causes the wall material and fluid conveying member 84 to become somewhat fluid and are then deformed to create an opening 92 defined by a bushing 94 to secure fitting 82 to fluid conveying member 84.

In the embodiment shown in FIGS. 9-12, at least one sealing member 98 is positioned between fitting 82 and fluid conveying member 84 on both the upstream and downstream side of bushing 94 to inhibit fluid leakage. Since the heat generated by the thermal drilling is very localized, sealing member 98 can be made from heat sensitive material and installed first without a concern they could be damaged. Moreover, in some instances, particularly where fitting 82 and fluid conveying member 84 are made of similar materials, such as brass, the formation of bushing 94 may cause the fitting and fluid conveying member material to flow together, weld or otherwise join to create a fluid tight seal. Moreover, when fitting 82 and fluid conveying member 84 are made of a metal, such as brass, steel or the like, even if the materials do not necessarily flow together, weld or join, the formation of bushing 94 may provide a metal-to-metal fluid tight seal. In either embodiment, sealing members 98 may be eliminated (see FIG. 15), when bushing 94 provides a fluid tight seal between fitting 82 and fluid conveying member 84.

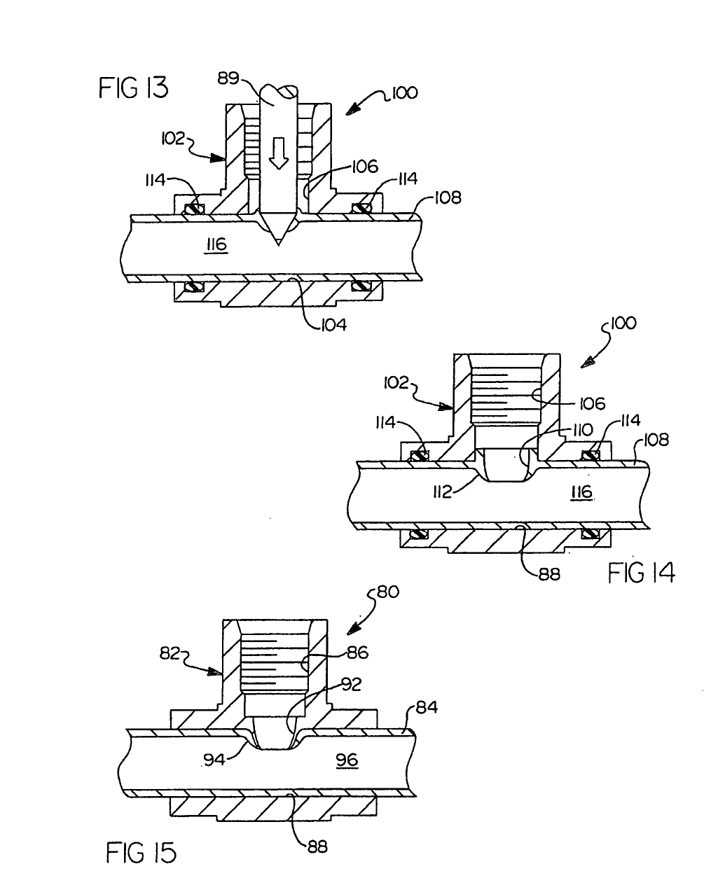

Referring to FIGS. 13 and 14, a connector 100 according to another embodiment of the present invention is shown. The embodiment shown in FIGS. 13 and 14 is substantially similar to connector 80 with at least one exception, namely, fitting 102 includes a first fluid duct 104 that is provided in communication with a second fluid duct 106. In other words, in fitting 102, there is no thickness of wall material 90 positioned between first and second fluid ducts 104, 106.

Like connector 80 shown in FIGS. 9-12, a thermal drilling process, such as a Formdrill® or Flowdrill® process, is used to penetrate and deform a wall of a fluid conveying member 108. As described above, friction and pressure causes the material of fluid conveying member 108 to become somewhat fluid and is then deformed to create an opening 110 defined by a bushing 112 that secures fitting 102 to fluid conveying member 108. Opening 110 provides an interior fluid passageway 116 of fluid conveying member 108 in communication with second fluid duct 106. Annular sealing members 114 may be positioned on the upstream and downstream sides of opening 110 to ensure a leak-free connection.

The present invention provides a method for securing a fitting, such as a “T-fitting”, to a fluid conveying member without brazing or otherwise introducing heat to the corrosion resistant coating of the connector. Thus, any corrosion resistant coating on the mating components is not damaged and recoating is no longer required. This saves time and expense when compared to a more traditional brazing process.

While the present invention is described as including a “T-fitting” with only one fluid conveyance port extending from the fluid conveying member, it is contemplated that a variety of fitting configurations may be appropriately adapted using the teachings of the present invention and similarly used to provide additional fluid flow paths. These fittings could require that only one fluid port be formed on the fluid conveying member or more than one could be required and formed using the teachings of the present invention. It is also contemplated that any number of outlet ports from the T-fitting or other fitting configuration could be utilized, such as a “Y-fitting” or a manifold with multiple outlet ports emanating from one or more “collars” or “bushings” formed in the fluid conveying member according to teachings of the present invention. Further, while the fluid conveying member is shown in FIGS. 4-15 as being generally cylindrical in cross-section, it may exhibit other cross-sectional profiles, such as a rectangular cross-section for example.

Among other features, the fitting of the present invention slides onto the fluid conveying member so only one fluid conveying member is needed, thereby eliminating the need for cutting the fluid conveying member and then orientating the two ends. The present invention also allows current industry accepted pre-coated tubing and plated (coated) fittings to be used, since the connector does not need to be recoated after assembly. To this end, the present invention eliminates the expensive operations of brazing and subsequent recoating of the assembly. Use of the present invention results in streamlined process flow during manufacturing, which reduces inventory, processing and lead time.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A fluid connector, comprising:
a fluid conveying member that includes an interior fluid passageway; and
a fitting that includes a first fluid duct and a second fluid duct in communication with the first fluid duct, the fluid conveying member sized for receipt in the first fluid duct and including an opening defined by a collar that extends into the second fluid duct to provide the interior fluid passageway of the fluid conveying member in communication with the second fluid duct, the collar configured to inhibit movement of the fitting on the fluid conveying member.

2. The fluid connector of claim 1, wherein the fitting includes at least one annular sealing member positioned between the fitting and the fluid conveying member both upstream and downstream of the second fluid duct.

3. The fluid connector of claim 1, wherein the fitting includes a pair of annular sealing members positioned between the fitting and the fluid conveying member both upstream and downstream of the second fluid duct.

4. The fluid connector of claim 1, wherein the collar is a deformed portion of a wall of the fluid conveying member.

5. A fluid connector, comprising:
a fluid conveying member that includes an interior fluid passageway; and
a fitting that includes a first fluid duct and a second fluid duct in communication with the first fluid duct, the fluid conveying member sized for receipt in the first fluid duct and including an opening defined by a bushing that secures the fitting to the fluid conveying member and provides the interior fluid passageway of the fluid conveying member in communication with the second fluid duct.

6. The fluid connector of claim 5, wherein the bushing is a thermal formed bushing.

7. The fluid connector of claim 5, wherein the bushing is a leak resistant joint.

8. The fluid connector of claim 5, wherein the bushing includes material from the fitting and the fluid conveying member.

9. The fluid connector of claim 5, wherein the fitting includes at least one annular sealing member positioned between the fitting and the fluid conveying member both upstream and downstream of the second fluid duct.

10. A fluid connector, comprising:
a fluid conveying member that includes an interior fluid passageway; and
a fitting that includes a first fluid duct and a second fluid duct in communication with the first fluid duct, the fluid conveying member sized for receipt in the first fluid duct and including an opening defined by a retaining formation that secures the fitting to the fluid conveying member and provides the interior fluid passageway of the fluid conveying member in communication with the second fluid duct, and at least one annular sealing member positioned between the fitting and the fluid conveying member both upstream and downstream of the second fluid duct.

11. The fluid connector of claim 10, wherein the retaining formation is one of a collar and a bushing.

12. The fluid connector of claim 11, wherein the bushing is a thermal formed bushing.

13. The fluid connector of claim 11, wherein the bushing is a leak resistant joint.

14. A method of assembling a fluid connector, comprising:
providing a fluid conveying member having an interior fluid passageway and a fitting that includes a first fluid duct and a second fluid duct in communication with the first fluid duct;
providing a tool for creating an opening in the fluid conveying member to provide the interior fluid passageway of the fluid conveying member in communication with the second fluid duct;
inserting the fluid conveying member into the first fluid duct of the fitting;
creating a pilot hole in the fluid conveying member by extending the tool through the second fluid duct and drilling into the fluid conveying member;
extending at least one forming member from the tool; and
creating the opening by removing the tool and deforming a portion of the fluid conveying member adjacent the pilot hole to create the opening.

15. The method of claim 14, wherein the step of creating the pilot hole and forming the collar is performed while rotating the tool.

16. The method of claim 14 further including the step of positioning at least one annular sealing member between the fitting and the fluid conveying member both upstream and downstream of the second fluid duct.

17. A method of assembling a fluid connector, comprising:
providing a fluid conveying member having an interior fluid passageway and a fitting that includes a first fluid duct and a second fluid duct;
providing a thermal forming tool for creating an opening in the fluid conveying member to provide the interior fluid passageway of the fluid conveying member in communication with the second fluid duct;
inserting the fluid conveying member into the first fluid duct of the fitting; and
creating the opening in the fluid conveying member by heating the fluid conveying member with the thermal forming tool, penetrating the fluid conveying member with the thermal forming tool, and displacing a portion of the fluid conveying member to prevent removal of the fluid conveying member from the fitting.

18. The method of claim 17, wherein the creating step is further defined by frictionally heating the fluid conveying member with the thermal forming tool.

19. The method of claim 17, wherein the second fluid duct is separated from the first fluid duct by a wall member and the creating step is further defined by heating the wall member and the fluid conveying member with the thermal forming tool, penetrating the wall member and the fluid conveying member with the thermal forming tool, and displacing a portion of the wall member and the fluid conveying member to prevent removal of the fluid conveying member from the fitting.

20. The method of claim 19, wherein displacing a portion of the wall member and the fluid conveying member includes displacing a portion of the member and the fluid conveying member to form a bushing.

21. The method of claim 19, wherein the creating step is further defined by frictionally heating the wall member and the fluid conveying member with the thermal forming tool.

22. The method of claim 19, wherein the creating step is further defined by joining the displaced portion of the wall member and the fluid conveying member to create a fluid-tight seal.

23. The method of claim 19, wherein the creating step is further defined by rotating the thermal forming tool while heating and penetrating the wall member and the fluid conveying member.

24. The method of claim 17 further including the step of positioning at least one annular sealing member between the fitting and the fluid conveying member both upstream and downstream of the second fluid duct.

25. A method of assembling a fluid connector, comprising:
providing a fluid conveying member having an interior fluid passageway and a fitting that includes a first fluid duct and a second fluid duct in communication with the first fluid duct;
providing a tool for creating an opening in the fluid conveying member to provide the interior fluid passageway of the fluid conveying member in communication with the second fluid duct;
inserting the fluid conveying member into the first fluid duct of the fitting;
extending the tool through the second fluid duct and into the fluid conveying member; and
deforming the fluid conveying member using the tool to create the opening and to secure the fitting to the fluid conveying member.

26. The method of claim 25, wherein the deforming step includes creating a pilot hole in the fluid conveying member by extending the tool through the second fluid duct and into the fluid conveying member, extending at least one forming member from the tool, and removing the tool and deforming a portion of the fluid conveying member adjacent the pilot hole.

27. The method of claim 25, wherein the deforming step includes heating the fluid conveying member with the tool, penetrating the fluid conveying member with the tool, and displacing a portion of the fluid conveying member adjacent the opening to prevent removal of the fluid conveying member from the fitting.

28. The method of claim 25, wherein the second fluid duct is separated from the first fluid duct by a wall member and the deforming step is further defined by heating the wall member and the fluid conveying member with the tool, penetrating the wall member and the fluid conveying member with the tool, and displacing a portion of the wall member and the fluid conveying member to prevent removal of the fluid conveying member from the fitting.
